(19) United States
(12) Patent Application Publication
(10) Pub. No.: US 2023/0043295 A1
(43) Pub. Date: Feb. 9, 2023

(54) HIGH TEMPERATURE RESISTANT B-STAGEABLE EPOXY ADHESIVE AND ARTICLE MANUFACTURED THEREFROM

(71) Applicant: 3M INNOVATIVE PROPERTIES COMPANY, St. Paul, MN (US)

(72) Inventors: Dong Li, Shanghai (CN); Zheng Guan, Shanghai (CN)

(21) Appl. No.: 17/757,124

(22) PCT Filed: Dec. 27, 2019
(86) PCT No.: PCT/CN2019/129103

§ 371 Date: Jun. 9, 2022

(51) Int. Cl. C09J 163/00; C09J 7/38

(52) U.S. Cl. CPC C09J 163/00; C09J 7/38; C09J 2463/00; C09J 2467/00; C09J 2475/00; C09J 2203/326

(57) ABSTRACT

The present disclosure relates to a B-stageable epoxy adhesive composition and an article manufactured therefrom. The B-stageable epoxy adhesive composition comprises (A) 20% to 50% by weight of a first epoxy resin with an epoxide equivalent of 5000 g/eq or more; (B) 5% to 20% by weight of a second epoxy resin with an epoxide equivalent of 800 g/eq or less and having 2 to 4 epoxy functional groups; (C) 5% to 30% by weight of a carboxyl terminated polyester; (D) 5% to 15% by weight of a poly-isocyanate modified polyester; and (E) 0.1% to 0.5% by weight of a crosslinking agent containing 2 or more aziridine groups, all the content percentages are based on the total weight of the B-stageable epoxy adhesive composition. The B-stageable epoxy adhesive composition and the related products could be widely used as insulation protection for battery management, bus bar, transformers and other markets with a good balance between a high bonding strength and a high temperature resistance, and others.

### TECHNICAL FIELD

The present disclosure generally relates to the field of adhesive application. More specifically, the present disclosure relates to a high temperature resistant B-stageable epoxy adhesive and an article manufactured therefrom.

### BACKGROUND ART

Along with the new market and industrial trend, the electrical devices and equipment become smaller, thinner, lighter and high-power density, better heat resistance insulation material with good thermal conductive performance become more and more important for insulation protection in electrical market. The insulation tape with rubber based PSA or acrylic PSA is one key type of the insulation material for electrical device and equipment. Generally, the temperature rating of the materials is class B or below, and the thermal degradation of these known materials at higher temperature would result in a loss of adhesion and other performances.

EP1275673 related to an epoxy resin composition a cure article thereof, a novel epoxy resin used therein, a polyhydric phenol compound suited for used as an intermediate thereof, and a process for preparing the same. One of the objects to be achieved by the present invention is to exert the heat resistance, the moisture resistance, the dielectric performances and the flame-resistant effect required of electric or electronic materials such as semiconductor encapsulating materials and varnishes for circuit boards in the epoxy resin composition.

CN100336841C disclosed an epoxy resin roughening and curing agent. The epoxy resin roughening and curing agent consists of tree-shaped polyamide-amine polymer 10-60 wt %, saturated fatty polybasic amine 10-70 wt % and aromatic polybasic amine 10-45 wt % and is prepared through mixing tree-shaped polyamide-amine polymer, saturated fatty polybasic amine and aromatic polybasic amine. The preparation process has low cost. Compared with epoxy resin with saturated fatty polybasic amine and aromatic polybasic amine, the epoxy resin with the said epoxy resin roughening and curing agent has 180% raised impact toughness, and other important performances maintained. In addition, the epoxy resin roughening and curing agent has wide curing temperature range from room temperature to 120 degree Centigrade (° C.) and adjustable curing period, and thus makes epoxy resin possess widened application range and raised application value. thermal conductive epoxy resin which is produced by mixing 20 wt % magnesia clinker powder as a filler with 80 wt % polymer material comprising epoxy resin, curing agent, curing accelerator and pigment. The magnesia clinker powder is obtained by calcinating a magnesite at 1700-1800° C. to make a periclase crystalline particle.

CN103897643 discloses a room-temperature cured high heat-proof epoxy adhesive which comprises components A and B. The component A comprises the following components in parts by weight: 80-100 parts of epoxy resin, 0-3 parts of coupling agent, 0-30 parts of diluent, 0-20 parts of flexibilizer, 80-120 parts of heatproof filler, 0-5 parts of nano filler and 0-3 parts of thixotropic agent. The component B comprises the following components in parts by weight: 50-100 parts of curing agent, 0-3 parts of accelerant, 80-120 parts of heatproof filler, 0-5 parts of nano filler and 0-3 parts of thixotropic agent. The epoxy adhesive meets the demand of the adhesive in adhesive shearing strength and room-temperature shearing strength and is good in toughness. As the raw materials are common products in the market, the adhesive is simple and easy to get and low in cost.

CN1079922813A disclose a B-staged epoxy adhesive composition and a coating film prepared by same, and this composition endows the coating film very high bonding force, excellent high temperature resistance, chemical resistance and flame retardant.

CN108026424A disclose a B-staged epoxy adhesive composition for providing in areas requiring good bond strength, toughness, shelf life and aging properties, and functional properties such as heat resistance and flame retardancy. However, the peel strength and the heat resistance of this adhesive composition/film are still lower and thus need to be further improved.

CN108291129A discloses a novel B-staged adhesive composition which can be achieved when an epoxy resin, a carboxyl terminated butadiene-acrylonitrile copolymer and a polyfluorene modified phenolic resin are mixed at a specific ratio.

Therefore, there is a need to develop a new B-stageable epoxy adhesive composition so as to provide a better solution for bonding in the field of requiring good functions in terms of heat resistance, and adhesion strength, or the like.

### SUMMARY OF THE INVENTION

For the purpose of developing a B-stageable epoxy adhesive composition with good heat resistance, good adhesion strength, or the like, especially the balance among these properties, in the present disclosure, a new B-staged epoxy adhesive composition, as well as an article manufacture therefrom are developed.

In an aspect, the present disclosure provides a B-stageable epoxy adhesive composition, comprising: (A) 20% to 50% by weight of a first epoxy resin with an epoxide equivalent of 5000 g/eq or more; (B) 5% to 20% by weight of a second epoxy resin with an epoxide equivalent of 800 g/eq or less and having 2 to 4 epoxy functional groups; (C) 5% to 30% by weight of a carboxyl terminated polyester; (D) 5% to 15% by weight of a poly-isocyanate modified polyester having a glass transition temperature Tg of −13° C. to 30° C.; and (E) 0.1% to 0.5% by weight of a crosslinking agent containing 2 or more aziridine groups, wherein all the content percentages are based on the total weight of the B-stageable epoxy adhesive composition.

In some preferred embodiments, the first epoxy resin has a weight average molecular weight Mw of 10,000 g/mol or more.

In some preferred embodiments, the first epoxy resin is selected from the group consisting of bisphenol A epoxy resin, bisphenol F epoxy resin, phenolic epoxy resin, glycidyl ether epoxy resin, and a combination thereof.

In some preferred embodiments, the first epoxy resin is present in the B-stageable adhesive composition in an amount of 35% to 45% by weight, based on the total weight of the B-stageable adhesive composition.

In some preferred embodiments, the second epoxy resin has a weight average molecular weight Mw of 200˜2,000 g/mol.

In some preferred embodiments, the second epoxy resin is selected from the group consisting of polyurethane modified bisphenol A epoxy resin, polyurethane modified bisphenol F epoxy resin, polyurethane modified phenolic epoxy resin, polyurethane modified trisphenolmethane epoxy resin, polyurethane modified glycidyl amine epoxy resin, polyurethane modified aminophenol epoxy resin, polyurethane modified naphthalene epoxy resin, and a combination thereof.

In some preferred embodiments, the second epoxy resin is present in the B-stageable adhesive composition in an amount of 6% to 10% by weight, based on the total weight of the B-stageable adhesive composition.

In some preferred embodiments, the carboxyl terminated polyester has an acid value of 20˜80 mg KOH/g.

In some preferred embodiments, the poly-isocyanate modified polyester has a weight average molecular weight Mw of 20,000 g/mol or more.

In some preferred embodiments, the carboxyl terminated polyester or the poly-isocyanate modified polyester comprises a dicarboxylic acid unit and a glycol unit, wherein the dicarboxylic acid unit comprises one or more of succinic acid, adipic acid, cyclohexane diacid, suberic acid, phthalic acid, naphthalene acid, trimellitic acid, or pyromellitic acid, and the glycol unit comprises one or more of ethylene glycol, propylene glycol, butanediol, pentanediol, hexanediol, octanediol, decanediol, diethylene glycol, dipropylene glycol, dimethylolpropane, or dimethylolethane.

In some preferred embodiments, the carboxyl terminated polyester is selected from carboxyl terminated phthalate polyester, carboxyl terminated adipate polyester, or a combination thereof.

In some preferred embodiments, the poly-isocyanate modified polyester is phthalate polyester, poly-isocyanate modified adipate polyester or a combination thereof, which is modified by a poly-isocyanate selected from tolylene diisocyanate, diphenyl methane diisocyanate, hexamethylene diisocyanate, isophorone diisocyanate, or a combination thereof.

In some preferred embodiments, the poly-isocyanate modified polyester has a glass transition temperature Tg of −11° C. to 16° C.

In some preferred embodiments, the crosslinking agent is 1,1′-isophthaloyl bis(2-methylaziridine), Trimethylolpropane tris(2-methyl-1-aziridinepropionate), 2-((3-Aziridin-1-ylpropionyl)methyl)-2-ethylpropane-1,3-diyl bis(aziridine-1-propionate), or a combination thereof.

In some preferred embodiments, the B-stageable adhesive composition further comprises a solvent. Preferably, the solvent is selected from N,N-Dimethyl formamide, methyl ethyl ketone (MEK), hexane, heptane, cyclohexane, toluene, xylene, or a combination thereof. Preferably, the solvent is present in the B-stageable adhesive composition in an amount of 30% to 70% by weight, based on the total weight of the B-stageable adhesive composition.

In some preferred embodiments, the B-stageable adhesive composition further comprises a toughener, a flame retardant, or a combination thereof.

In some preferred embodiments, the toughener is present in the B-stageable adhesive composition in an amount of 0.5% to 2.0% by weight, based on the total weight of the B-stageable adhesive composition.

In some preferred embodiments, the flame retardant is present in the B-stageable adhesive composition in an amount of 1.0% to 30.0% by weight, based on the total weight of the B-stageable adhesive composition.

In another aspect, the present disclosure provides an article comprising a substrate and a coating formed of the adhesive composition described above on a surface of the substrate.

In some preferred embodiments, the article is in a form of plate, plate, tape, roll, film or tube.

In the present disclosure, by specifically selecting two kinds of different epoxy resins, two kinds of different polyesters and using a specific crosslinking agent at a specific weight ratio, a B-stageable epoxy adhesive composition with a good heat resistance, a good adhesion strength, or the like, especially the balance among these properties, as well as an article manufacture therefrom are obtained.

Furthermore, the crosslinking agent containing 2 or more aziridine groups, such as 1,1′-Isophthaloyl bis(2-Methylaziridine) in the B-stageable epoxy adhesive composition of the present disclosure can be reacted with both the epoxy resins and the carboxyl groups in the polyesters, so that a cross linked network is formed in the B-stageable epoxy adhesive composition, which can significantly improve both the heat resistance and the adhesion strength thereof.

Moreover, the B-stageable epoxy adhesive composition and the related products of the present disclosure can be widely used as insulation protection for Battery management, Bus bar, transformers and other markets with a good balance between a high bonding strength and a high temperature resistance, and other properties such as chemical resistance.

### DETAILED DESCRIPTION OF THE INVENTION

In order to develop a new B-stageable epoxy adhesive composition having a good balance between high adhesion strength and high heat resistance or high temperature resistance, the inventors have made intensive and wide studies. The present inventors have surprisingly found that, when two kinds of different epoxy resins, two kinds of different polyesters, and a specific crosslinking agent containing 2 or more aziridine groups such as 1,1′-Isophthaloyl bis(2-Methylaziridine) are mixed at a specific weight ratio, a B-stageable epoxy adhesive composition which has a good heat resistance, a good adhesion strength, or the like, especially the balance among these properties may be achieved.

An aspect of the present disclosure provides a B-stageable epoxy adhesive composition, comprising: (A) 20% to 50% by weight of a first epoxy resin with an epoxide equivalent of 5000 g/eq or more; (B) 5% to 20% by weight of a second epoxy resin with an epoxide equivalent of 800 g/eq or less and having 2 to 4 epoxy functional groups; (C) 5% to 30% by weight of a carboxyl terminated polyester; (D) 5% to 15% by weight of a poly-isocyanate modified polyester; and (E) 0.1% to 0.5% by weight of a crosslinking agent containing 2 or more aziridine groups, wherein all the content percentages are based on the total weight of the B-stageable epoxy adhesive composition.

As used herein, the term “B-stageable epoxy adhesive composition” has the traditional meaning, namely an epoxy resin based adhesive composition which can be subjected to a B-staging process, as known by those skilled in the art, unless otherwise specified. B-staging is a process that utilizes heat to remove the majority of a solvent from an adhesive composition, thereby allowing the construction to be “staged”. In between the processes of coating, assembling and curing of an adhesive composition, the adhesive composition can be held for a period of time, without sacrificing the related performances thereof.

The components as used in the B-stageable epoxy adhesive composition of the present disclosure will be described in detail below.

### (A) First Epoxy Resin

In the present disclosure, a first epoxy resin with a higher epoxide equivalent is contained in the adhesive composition. In the present disclosure, the first epoxy resin has an epoxide equivalent of 5000 g/eq or more, preferably epoxide equivalent of 5000 to 10000 g/eq.

Based on the total weight of the B-stageable epoxy adhesive composition, the first epoxy resin is present in the B-stageable adhesive composition in an amount of 20% to 50% by weight, preferably 35% to 45% by weight.

In the present disclosure, preferably, the first epoxy resin may have a weight average molecular weight Mw of 10,000 g/mol or more, advantageously 12,000 g/mol or more, advantageously 15,000 g/mol or more, advantageously 20,000 g/mol or more, and advantageously 25,000 g/mol or more. As found by the present inventors, if this weight average molecular weight Mw is less than 10,000 g/mol, it may degrade the peel strength at room temperature of the adhesive composition.

In the present disclosure, the specific kinds of the first epoxy resin to be used in the present invention are not specifically limited as long as it satisfies the related requirements. Preferably, the first epoxy resin may be selected from the group consisting of bisphenol A epoxy resin, bisphenol F epoxy resin, phenolic epoxy resin, glycidyl ether epoxy resin, and a combination thereof, and the like. Such epoxy resin may be commercially available, and one specific example of the first epoxy resin is 40AXM40 (trade name) from Shandong Shengquan New Materials Chemical Co., Ltd. which is a bisphenol A epoxy resin having an epoxide equivalent of 5000 to 10000 g/eq (with weight average molecule weight of ˜38,000 g/mol) and in a form of solution with a solid content of 40% by weight.

As found by the present inventors, when the first epoxy resin is used in the above amount range, the B-stageable adhesive composition has good tackiness, and the cured product thereof has a good balance of adhesion strength and heat resistance.

### (B) Second Epoxy Resin

In the present disclosure, a second epoxy resin with a lower epoxide equivalent is contained in the adhesive composition. In the present disclosure, the second epoxy resin is a poly-functional epoxy resin, which has an epoxide equivalent of 800 g/eq or less, advantageously 100 g/eq to 700 g/eq, and advantageously 100 g/eq to 500 g/eq, for example ˜180 g/eq, and has 2 to 4, for example 2.5, 3.3 or 4 epoxy functional groups.

Based on the total weight of the B-stageable epoxy adhesive composition, the second epoxy resin is present in the B-stageable adhesive composition in an amount of 5% to 20% by weight, preferably 6% to 10% by weight.

In the present disclosure, preferably, the second epoxy resin may have a weight average molecular weight Mw of 200 to 2,000 g/mol, advantageously 250 to 1500 g/mol, advantageously 250 to 1200 g/mol, and advantageously 300 to 1,000 g/mol.

In the present disclosure, the specific kinds of the second epoxy resin to be used in the present invention are not specifically limited as long as it satisfies the related requirements. Preferably, the second epoxy resin may be selected from modified epoxy resins, for example, polyurethane (PU) modified epoxy resins. Preferably, the second epoxy resin is selected from the group consisting of polyurethane modified bisphenol A epoxy resin, polyurethane modified bisphenol F epoxy resin, polyurethane modified phenolic epoxy resin, polyurethane modified trisphenolmethane epoxy resin, polyurethane modified glycidyl amine epoxy resin, polyurethane modified aminophenol epoxy resin, polyurethane modified naphthalene epoxy resin, and a combination thereof, and the like. Such second epoxy resin may be commercially available, and specific examples thereof are EPN1179 (trade name) and EPN1183 (trade name) from Huntsman International LLC.; and NPPN638S (trade name) from Nanya epoxy Co., Ltd.

As found by the present inventors, when the second epoxy resin having the above epoxide equivalent and 2 to 4 epoxy functional groups is used in the above amount range, the B-stageable adhesive composition has good tackiness, and the coating formed from the adhesive composition can be effectively cured with good adhesion strength and high heat resistance.

The combination of components (A) and (B) is also called as a two-component epoxy resin system according to the present disclosure. According to certain embodiments, the present adhesive composition preferably comprises the combination of a bisphenol epoxy resin with a higher epoxide equivalent and a lower weight average molecular weight and a polyurethane modified bisphenol epoxy resin with a lower epoxide equivalent and a lower weight average molecular weight as the two-component epoxy resin system. If the contents of the first epoxy resin and the second epoxy resin are in the above ranges, it can provide a better balance on the adhesion strength and heat resistance.

### (C) Carboxyl Terminated Polyester and (D) Poly-Isocyanate Modified Polyester

In the present disclosure, a carboxyl terminated polyester and a poly-isocyanate modified (hydroxyl-terminated) polyester are contained in the adhesive composition of the present disclosure. Not wished to be bound to a particular theory, it is believed that such carboxyl terminated polyester and poly-isocyanate modified polyester act as a toughener to further balance the adhesion strength and heat resistance of a coating obtained from the adhesive composition after being cured. Such toughener has functional groups which under the conditions of the curing reaction especially under high temperature, can react with the above-mentioned epoxy resins and the crosslinking agent described hereafter so as to improve the adhesion strength and heat resistance of the coating formed by curing.

Based on the total weight of the B-stageable epoxy adhesive composition, the carboxyl terminated polyester is present in the B-stageable adhesive composition in an amount of 5% to 30% by weight, and the poly-isocyanate modified polyester is present in the B-stageable adhesive composition in an amount of 5% to 15% by weight.

In the present disclosure, preferably, the carboxyl terminated polyester has an acid value of 20˜80 mg KOH/g, advantageously 20-60 mg KOH/g, advantageously 20-50 mg KOH/g, and advantageously 29-35 mg KOH/g.

In the present disclosure, preferably, the poly-isocyanate modified polyester has a weight average molecular weight Mw of 20,000 g/mol or more, advantageously 25,000 g/mol or more, advantageously 30,000 g/mol or more, and advantageously 35,000 g/mol or more.

In the present disclosure, preferably, the carboxyl terminated polyester or the poly-isocyanate modified polyester comprises a dicarboxylic acid unit and a glycol unit, wherein the dicarboxylic acid unit comprises one or more of succinic acid, adipic acid, cyclohexane diacid, suberic acid, phthalic acid, naphthalene acid, trimellitic acid, or pyromellitic acid, and the glycol unit comprises one or more of ethylene glycol, propylene glycol, butanediol, pentanediol, hexanediol, octanediol, decanediol, diethylene glycol, dipropylene glycol, dimethylolpropane, or dimethylolethane.

In the present disclosure, preferably, the carboxyl terminated polyester is selected from carboxyl terminated phthalate polyester, carboxyl terminated adipate polyester, or a combination thereof. Such carboxyl terminated polyester may be commercially available, and one specific example thereof is SJ4866 (trade name) from Anhui Shenjian New Materials Co., Ltd.

In the present disclosure, the poly-isocyanate modified polyester has a glass transition temperature Tg of −13° C. to 30° C., preferably −11° C. to 16° C.

In the present disclosure, preferably, the poly-isocyanate modified polyester is phthalate polyester, poly-isocyanate modified adipate polyester or a combination thereof, which is modified by a poly-isocyanate selected from tolylene diisocyanate, diphenyl methane diisocyanate, hexamethylene diisocyanate, isophorone diisocyanate, or a combination thereof. Such poly-isocyanate modified polyester may be obtained, for example, by modifying V3300, V3650 and V1801 (trade name) from Bostik Inc. with a poly-isocyanate before use.

As found by the present inventors, when the carboxyl terminated polyester and the poly-isocyanate modified polyester are used in the above amount ranges, the improvement of toughness may be achieved and a balance between toughness and adhesion strength will be established.

### (E) Crosslinking Agent

In the present disclosure, a crosslinking agent containing 2 or more, for example 2 or 3 aziridine groups is contained in the adhesive composition of the present disclosure.

Based on the total weight of the B-stageable epoxy adhesive composition, the crosslinking agent is present in the B-stageable adhesive composition in an amount of 0.1% to 0.5% by weight.

In the present disclosure, preferably, the crosslinking agent containing 2 or more aziridine groups may be 1,1′-isophthaloyl bis(2-methylaziridine), Trimethylolpropane tris(2-methyl-1-aziridinepropionate), 2-((3-Aziridin-1-ylpropionyl)methyl)-2-ethylpropane-1,3-diyl bis(aziridine-1-propionate), or a combination thereof. Such crosslinking agent may be commercially available, and specific examples thereof are HX-752 (trade name) from Shenzhen Hongyuan Chemical New Material Technology Ltd., and Sac-100 (trade name) from Shanghai UN Chemical Co., Ltd.

Typically, 1,1′-Isophthaloyl bis(2-Methylaziridine) or other aziridine crosslinking agents are normally used in an acrylic pressure-sensitive adhesive (PSA) system, and the main function is to form a linear crosslinked structure of the linear polymer of the acrylic polymer in the pressure-sensitive adhesive system, thereby providing the cohesive strength of the polymer molecules, so that it can be used as pressure-sensitive adhesives, and in theory, it also has a certain effect of improving heat resistance, but this is not its fundamental purpose;

Typically, the crosslinking agent of a general epoxy resin system is a crosslinking agent capable of directly reacting with an epoxy group, such as an amine or an acid anhydride. The crosslinking agent used in the present disclosure does not directly react with the epoxy group, so the epoxy adhesive generally does not use this kind of crosslinking agent;

The present inventors have surprisingly found that the crosslinking agent containing 2 or more aziridine groups can improve the heat resistance of the B-stageable epoxy adhesive composition of the present disclosure. The improvement of heat resistance can be explained in two aspects. On one hand, it is the use of the cross-linking agent in epoxy adhesive. This cross-linking agent acts like a bridge, in the original glue reaction system, which adds a reaction link point to obtain a larger cross-linking system, reduces the ability of molecular motion and thus improves heat resistance. On the other hand, it is the special modified polyester used as a toughening agent mentioned above. Such modified polyester resin is used as a toughening agent. The multifunctional isocyanate is treated for a period of time, so that the addition ratio thereof is greatly reduced (5% to 15%), and the good toughening effect is ensured without significantly affecting the heat resistance of the glue.

Below Table 1 showed the chemical structures of some typical aziridines crosslinking agents.

TABLE 1

| | |
|---|---|
| 1,1′-Isophthaloyl bis(2-Methylaziridine)(HX-752) | 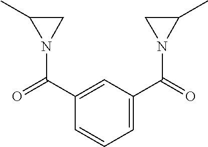 |
| Trimethylolpropane tris(2-methyl-1-aziridinepropionate)(Sec-100) | 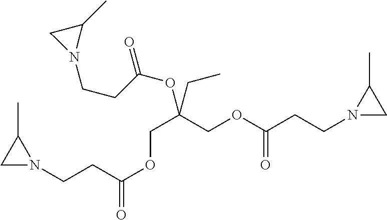 [SMILES: CCC(COC(=O)CCN1CC1C)(COC(=O)CCN1CC1C)OC(=O)CCN1CC1C] |
| 2-((3-Aziridin-1-ylpropionyl)methyl)-2-ethylpropane- 1,3-diyl bis(aziridine-1-propionate) | 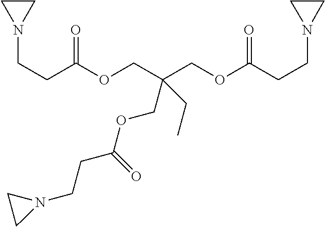 [SMILES: CCC(COC(=O)CCN1CC1)(COC(=O)CCN1CC1)COC(=O)CCN1CC1] |

Without being bound to a particular theory, an estimated reaction mechanism between aziridine and carboxyl is showed as below.

On one hand, this crosslinking agent is reacted with the carboxyl terminated polyester resin in the B-stageable epoxy adhesive composition to increase the crosslinking density, which will help improve the heat resistance obviously.

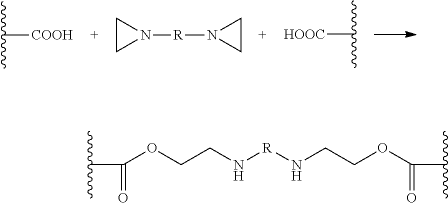

On the other hand, the poly-isocyanate modified polyester resin is also innovative for the B-stageable epoxy adhesive composition. Normally, an epoxy resin-based adhesive is difficult to be coated on a PET film, and the polyester resins with low Tg can be used as the toughener to increase the bonding force to the film backing. However, the adding rate of the polyester toughener will be high, general 30% by weight, and even more. It will decrease the heat resistance as well as the Tg of the adhesive system, which will be in-convenient in the applications that need no or low initial tackiness. By using poly-isocyanate modified polyesters, the adding rate can be reduced to 5˜15% by weight, and this will lower the influence on the adhesive Tg and heat resistance. And furthermore, the adhesion to PET film is improved obviously compared with normal polyester resin.

By using isocyanate modified polyester and poly-functional aziridine crosslinking agents into the epoxy based adhesive composition, it will bring a well-balanced system with good heat resistance and bonding strength at room temperature, especially, much higher heat resistance than the existed solutions.

Specially, the crosslinking agent such as 1,1′-isophthaloyl bis(2-Methylaziridine) is added into the adhesive composition, and upon heat activation, the epoxy groups of the epoxy resin and the carboxyl groups of the polyester will react with the crosslinking agent, and thus a cross linked network is formed, which will help improve the heat resistance performance of the cured coating obviously.

### Other Optional Components

In addition to the above components, the B-stageable adhesive composition of the present disclosure may comprise one or more of the following components, such as solvents, toughener, flame retardant, antioxidants, antifoaming agents, pigments, fillers, surfactants, and the like.

According to certain preferred embodiments, a solvent may be contained in the adhesive composition to dissolve the related components e.g. the epoxy resins, the polyesters, the crosslinking agent, and other components. In the present disclosure, the solvent may be selected from the group consisting of N,N-Dimethyl formamide, methyl ethyl ketone (MEK), hexane, heptane, cyclohexane, toluene, xylene, or a combination thereof, and the like. Such solvents may be commercially available, and one specific example thereof is MEK (trade name) from Shanghai Xiangshun Fine Chemical Co., Ltd. In the present disclosure, preferably, based on the total weight of the B-stageable adhesive composition, the solvent is present in the B-stageable adhesive composition in an amount of 30% to 70% by weight.

According to certain preferred embodiments, a toughener may be contained in the adhesive composition to endow more toughness of the cured products. Such toughener is known in the art and is commercially available, for example Fortegra 100 (trade name) from Dow Chemical Company.

In the present disclosure, when necessary, a flame retardant may be contained in the adhesive composition so as to endow the articles obtained from the adhesive composition with excellent fire resistance. Preferably, the flame retardant is a halogen-free flame retardant taking consideration of the environmental issue. The flame retardant which can be used in the present disclosure may be selected from organic flame retardant and inorganic flame retardant, such as aluminum hydroxide, magnesium hydroxide, MgO, ZnO, organophosphorus salt, phosphate, phosphorus containing polymer, nitrogen containing polymer, or a combination thereof. According to certain embodiments, based on the total weight of the adhesive composition, the content of the flame retardant is 1.0% to 30.0% by weight.

In the present disclosure, when necessary, an antioxidant may be contained in the adhesive composition to provide an advantage of better aging performance. According to certain embodiments, the antioxidant may be selected from the group consisting of tea polyphenols, Vitamin E, flavonoid, Butylated hydroxyanisole, Butylated hydroxytoluene, tert-Butyl hydroquinone. According to certain embodiments, based on the total weight of the adhesive composition, the content of the antioxidant is 0.1˜5% by weight.

In the present disclosure, when necessary, an antifoaming agent may be contained in the adhesive composition to provide an advantage of good coating surface. According to certain embodiments, the antifoaming agent may be selected from the group consisting of insoluble oils, polydimethylsiloxanes and other silicones, certain alcohols, stearates, glycols, or a combination thereof. According to certain embodiments, based on the total weight of the adhesive composition, the content of the antifoaming agent is 0.011% by weight.

In the present disclosure, when necessary, a pigment may be contained in the adhesive composition to provide an advantage of color of the coating. According to certain embodiments, the pigment may be selected from the group consisting of carbon black, ivory black, Cadmium pigments, Chromium, Cobalt pigments, Copper, Iron oxide, Lead pigments, Manganese pigments, Mercury pigments, Titanium pigments, Zinc pigments. According to certain embodiments, based on the total weight of the adhesive composition, the content of the pigment is 0.1˜30% by weight.

In the present disclosure, when necessary, a filler may be contained in the adhesive composition to modify or improve the properties of the adhesive composition, in which the filler may be selected from conductive filler such as carbon black, Nickel powder, Copper powder, golden power, silver powder; thermal conductive filler such as boron nitride (BN), aluminum hydride (ATH); or other fillers such as CaCO₃, SiO₂, clay, chalk, glass fibers and so on. According to certain embodiments, based on the total weight of the adhesive composition, the content of the filler is 0.1˜30% by weight.

In the present disclosure, when necessary, a surfactant may be further contained in the adhesive composition to provide an advantage of good surface of the coating. According to certain embodiments, the surfactant may be selected from the group consisting of sulfate, sulfonate, phosphate, ammonium lauryl sulfate, sodium lauryl sulfate (SDS, sodium dodecyl sulfate) and the related alkyl-ether sulfates sodium laureth sulfate, also known as sodium lauryl ether sulfate (SLES), sodium myreth sulfate, or the like. According to certain embodiments, based on the total weight of the adhesive composition, the content of the surfactant is 0.01˜5% by weight.

For example, when one or more of these components are present in the adhesive with a suitable ratio, the coating formed from the B-stageable adhesive composition of the present disclosure may be endowed a very high bonding force to a substrate such as a copper plate at high temperature (>0.7 N/mm at 105° C.), together with good flame resistance and other performances.

In the present disclosure, there is no any limitation for the method of preparing the B-stageable adhesive composition. According to certain embodiments, a method of preparing the B-stageable adhesive composition comprises the step of mixing all components thereof uniformly. According to certain embodiments, the temperature of the mixing step may be 5˜60° C., and the pressure of the mixing step may be 0.5-2 atm.

In the present disclosure, the above-mentioned components may be mixed together with solvents to form a one-component package. And the obtained adhesive composition may be applied to the surface of a device such as electronic device by commonly known coating methods, and then be cured to provide an effective adhesion. Alternatively, the adhesive composition may be applied to the surface of a substrate such as a plate, a film, a plate, a tape and then be dried to provide a B-stageable article, such as an adhesive tape. The B-stageable article can be stored at a normal environment in a package or in a rolling form. Upon application, the B-stageable article may be applied to the devices and be further cured at a relatively high temperature and optional pressure to provide a completely cured article with heat resistance and flame retardance.

Accordingly, the present disclosure also relates to an article comprising a coating formed from the adhesive composition after being cured. Preferably, such article may be in a form of plate, plate, tape, roll, film or tube. According to certain embodiments, the article may have the following structures: the coating obtained from the adhesive composition of the present disclosure being disposed on a liner; the coating obtained from the adhesive composition of the present disclosure being disposed between a liner and a backing; a first coating obtained from the adhesive composition of the present disclosure being disposed on a liner, and then a backing and a second coating obtained from the adhesive composition of the present disclosure being disposed in sequence; and a backing being interposed between a first coating and a second coating.

According to certain embodiments, the article of the present disclosure may be manufactured by mixing the components of the adhesive composition to obtain a mixture; and coating the mixture onto a substrate, followed by drying the coated substrate. According to certain embodiments, the substrate may be a PET film. According to certain embodiments, the coated substrate may be dried at a temperature of 120° C. or less for a period of time allowing to form an article, such as several minutes to several hours. According to certain embodiments, the coating may be applied onto the surface of the substrate under a condition of under 25° C. and under atmospheric pressure.

The present disclosure further relates to use of the adhesive composition or the article according to the present disclosure in insulation application for electrical devices which comprise battery, collector, PCB, bus bar and transformer and so on.

### LISTING OF EMBODIMENTS

Embodiment 1 provides a B-stageable epoxy adhesive composition, comprising: (A) 20% to 50% by weight of a first epoxy resin with an epoxide equivalent of 5000 g/eq or more; (B) 5% to 20% by weight of a second epoxy resin with an epoxide equivalent of 800 g/eq or less and having 2 to 4 epoxy functional groups; (C) 5% to 30% by weight of a carboxyl terminated polyester; (D) 5% to 15% by weight of a poly-isocyanate modified polyester having a glass transition temperature Tg of −13° C. to 30° C.; (E) 0.1% to 0.5% by weight of a crosslinking agent containing 2 or more aziridine groups, wherein all the content percentages are based on the total weight of the B-stageable epoxy adhesive composition.

Embodiment 2 provides the B-stageable adhesive composition according to the embodiment 1, wherein the first epoxy resin has a weight average molecular weight Mw of 10,000 g/mol or more.

Embodiment 3 provides the B-stageable adhesive composition according to the embodiment 1 or 2, wherein the first epoxy resin is selected from the group consisting of bisphenol A epoxy resin, bisphenol F epoxy resin, phenolic epoxy resin, glycidyl ether epoxy resin, and a combination thereof.

Embodiment 4 provides the B-stageable adhesive composition according to any one of embodiments 1 to 3, wherein the first epoxy resin is present in the B-stageable adhesive composition in an amount of 35% to 45% by weight, based on the total weight of the B-stageable adhesive composition.

Embodiment 5 provides the B-stageable adhesive composition according to any one of embodiments 1 to 4, wherein the second epoxy resin has a weight average molecular weight Mw of 200˜2,000 g/mol.

Embodiment 6 provides the B-stageable adhesive composition according to any one of embodiments 1 to 5, wherein the second epoxy resin is selected from the group consisting of polyurethane modified bisphenol A epoxy resin, polyurethane modified bisphenol F epoxy resin, polyurethane modified phenolic epoxy resin, polyurethane modified trisphenolmethane epoxy resin, polyurethane modified glycidyl amine epoxy resin, polyurethane modified aminophenol epoxy resin, polyurethane modified naphthalene epoxy resin, and a combination thereof.

Embodiment 7 provides the B-stageable adhesive composition according to any one of embodiments 1 to 6, wherein the second epoxy resin is present in the B-stageable adhesive composition in an amount of 6% to 10% by weight, based on the total weight of the B-stageable adhesive composition.

Embodiment 8 provides the B-stageable adhesive composition according to any one of embodiments 1 to 7, wherein the carboxyl terminated polyester has an acid value of 20˜80 mg KOH/g.

Embodiment 9 provides the B-stageable adhesive composition according to any one of embodiments 1 to 8, wherein the carboxyl terminated polyester or the poly-isocyanate modified polyester comprises a dicarboxylic acid unit and a glycol unit, wherein the dicarboxylic acid unit comprises one or more of succinic acid, adipic acid, cyclohexane diacid, suberic acid, phthalic acid, naphthalene acid, trimellitic acid, or pyromellitic acid, and the glycol unit comprises one or more of ethylene glycol, propylene glycol, butanediol, pentanediol, hexanediol, octanediol, decanediol, diethylene glycol, dipropylene glycol, dimethylolpropane, or dimethylolethane.

Embodiment 10 provides the B-stageable adhesive composition according to any one of embodiments 1 to 9, wherein the carboxyl terminated polyester is selected from carboxyl terminated phthalate polyester, carboxyl terminated adipate polyester, or a combination thereof.

Embodiment 11 provides the B-stageable adhesive composition according to any one of embodiments 1 to 10, wherein the poly-isocyanate modified polyester is phthalate polyester, poly-isocyanate modified adipate polyester or a combination thereof, which is modified by a poly-isocyanate selected from tolylene diisocyanate, diphenyl methane diisocyanate, hexamethylene diisocyanate, isophorone diisocyanate, or a combination thereof.

Embodiment 12 provides the B-stageable adhesive composition according to any one of embodiments 1 to 11, wherein the poly-isocyanate modified (hydroxyl-terminated) polyester has a weight average molecule weight of 20,000 g/mol or more.

Embodiment 13 provides the B-stageable adhesive composition according to any one of embodiments 1 to 12, wherein the poly-isocyanate modified polyester has a glass transition temperature Tg of −11° C. to 16° C.

Embodiment 14 provides the B-stageable adhesive composition according to any one of embodiments 1 to 13, wherein the crosslinking agent is 1,1′-isophthaloyl bis(2-methylaziridine), Trimethylolpropane tris(2-methyl-1-aziridinepropionate), 2-((3-Aziridin-1-ylpropionyl)methyl)-2-ethylpropane-1,3-diyl bis(aziridine-1-propionate), or a combination thereof.

Embodiment 15 provides the B-stageable adhesive composition according to any one of embodiments 1 to 14, further comprising a solvent.

Embodiment 16 provides the B-stageable adhesive composition according to the embodiment 15, wherein the solvent is selected from N,N-Dimethyl formamide, methyl ethyl ketone (MEK), hexane, heptane, cyclohexane, toluene, xylene, or a combination thereof.

Embodiment 17 provides the B-stageable adhesive composition according to the embodiments 15 or 16, wherein the solvent is present in the B-stageable adhesive composition in an amount of 30% to 70% by weight, based on the total weight of the B-stageable adhesive composition.

Embodiment 18 provides the B-stageable adhesive composition according to any one of embodiments 1 to 17, further comprising a toughener, a flame retardant, or a combination thereof.

Embodiment 19 provides the B-stageable adhesive composition according to the embodiment 18, wherein the toughener is present in the B-stageable adhesive composition in an amount of 0.5% to 2.0% by weight, based on the total weight of the B-stageable adhesive composition.

Embodiment 20 provides the B-stageable adhesive composition according to the embodiment 18, wherein the flame retardant is present in the B-stageable adhesive composition in an amount of 1.0% to 30.0% by weight, based on the total weight of the B-stageable adhesive composition.

Embodiment 21 provides an article comprising a substrate and a coating formed of the adhesive composition according to any one of embodiments 1 to 20 on a surface of the substrate.

Embodiment 22 provides the article according to the embodiment 21, wherein the article is in a form of plate, plate, tape, roll, film or tube.

### EXAMPLES

Hereinafter, the present disclosure is further described with reference to the following examples and comparative examples, which are provided in the present disclosure for illustrative purpose and are not for limiting the scopes of the present disclosure.

It shall be understood that one skilled in the art can contemplate other various embodiments and make modifications thereto according to the teachings of the description without departing from the scope or spirit of the present disclosure. Therefore, the following embodiments are not intended to be limiting in any sense.

Unless otherwise specified, it shall be understood that all numbers which are used in the description and claims to represent feature sizes, quantities and physicochemical characteristics are modified by the term “approximate” in all cases. Therefore, unless otherwise oppositely stated, numerical parameters which are listed in the description and claims attached thereto are approximate values. One skilled in the art can properly change these approximate values according to the teachings disclosed herein so as to obtain desired characteristics. Numerical ranges which are expressed by using end points shall include all numbers and any range therein. For instance, the range 1-5 includes 1, 1.1, 1.3, 1.5, 2, 1.75, 3, 3.80, 4, and 5, etc.

Unless otherwise specified, all percentages used herein refer to weight percentages which are based on the total weight of the adhesive composition.

Raw Materials

The Raw materials used in the following illustrative examples of the present disclosure are commercial available and are listed in the following Table 2 by the trade name, chemical name and the vendor.

TABLE 2
Raw materials list

| Trade name | Description | Vendor name |
|---|---|---|
| 40AXM40 | A first epoxy resin (Bisphenol A epoxy resin, epoxide | Shandong Shengquan |
| | equivalent 5000~10000, solvent with 40% solid) | New Materials |
| | | Chemicals Co., Ltd. |
| SM609 | A first epoxy resin (Bisphenol A epoxy resin, epoxide | Jiangsu San-Mu group |
| | equivalent 2400~4000, solid) | Co., Ltd. |
| DER671 | A first epoxy resin (Bisphenol A epoxy resin, epoxide | Dow Chemical |
| | equivalent ~500, solid) | Company |
| V2700 | A hydroxyl terminated polyester (Polyester resin with | Bostik Inc. |
| | high molecule and Tg is 50° C. | |
| V3300 | A hydroxyl terminated polyester (Polyester resin with | Bostik Inc. |
| | high molecule and Tg is 16° C. | |
| V3650 | A hydroxyl terminated polyester (Polyester resin with | Bostik Inc. |
| | high molecule and Tg is −11° C. | |
| V1801 | A hydroxyl terminated polyester (Polyester resin with | Bostik Inc. |
| | high molecule and Tg is −20° C. | |
| N 100 | Polyisocyanate, HDI biuret, used for the modification | Covestro Deutschland |
| | of hydroxyl terminated polyester. | AG. |
| D80 | Dibutyltin dilaurate, Catalyst used for the modification | Hubei New Bluesky |
| | of hydroxyl terminated polyester. | New Material Inc. |
| EPN 1179 | A second epoxy resin (Multifunctional epoxy resin, | Huntsman |
| | functional degree is 2.5) | International LLC. |
| EPN 1183 | A second epoxy resin (Multifunctional epoxy resin, | Huntsman |
| | functional degree is 3.3) | International LLC. |
| NPPN638S | A second epoxy resin (Multifunctional epoxy resin, | Nanya epoxy Co., Ltd. |
| | functional degree is 4) | |
| Fortegra 100 | Toughener, segmented copolymer | Dow Chemical |
| | | Company |
| SJ4866 | A carboxyl terminated polyester | Anhui Shenjian New |
| | | Materials Co., Ltd. |
| HX-752 | A crosslinking agent (1,1′-Isophthaloyl | Shenzhen Hongyuan |
| | bis(2-Methylaziridine)) | Chemical New |
| | | Material Technology |
| | | Ltd. |
| Sac-100 | A crosslinking agent (Trimethylolpropane | Shanghai UN |
| | tris(2-methyl-1-aziridinepropionate)) | Chemical Co., Ltd. |
| MEK | A solvent (Methyl ethyl ketone) | Shanghai Xiangshun |
| | | Fine Chemical Co., |
| | | Ltd. |
| OP935 | A Flame retardant, phosphinate flame | Clariant |
| | retardant for adhesive applications | International Ltd. |

### Test Methods

The adhesion strength of the coating was evaluated by a “peel strength test” (180° peel strength at 25° C.), the heat resistance (namely 180° peel strength at 105° C. or 130° C.) of the coating was evaluated by adhesive oozing in “adhesive flow test”, and the bending simulation test was conducted to evaluate the toughness of the coating.

Initial Tackiness

Initial tackiness is an important performance of the B-stageable adhesive composition and will influence the application operation. This invention is aim to disclose a B-stageable adhesive film with good initial tackiness at room temperature (about 25° C.), and will be very suitable for die cutting and easily assembled for multi-layers film. Tackiness is evaluated in the application by measuring 180° peeling force at room temperature, according to ASTM D1000, after a heat aging test. Specifically, a sample of the adhesive film formed by a B-stageable adhesive composition coated on a 0.175 mm white PET film (BP, Foshan Dupont Company). The adhesive film is then cut into a size of 150 mm length and 25.4 mm width, and a 10-layer adhesive film sample is prepared by stacking ten of the adhesive films arranged in the same direction, then a 70 g/cm² pressure is applied to the 10-layer adhesive film sample, which is kept at 65° C. heat aging for 1 week. After heat aging test, the 10-layer adhesive film sample may stick together and the adhesion force to separate the samples is measured by 180° peel at room temperature.

The initial tackiness of the adhesive film at 25° C. was evaluated according to the Result Criterions shown in Table 3-1.

TABLE 3-1

| | |
|---|---|
| Initial tackiness at 25° C. | Result Criterions |

| | | |
|---|---|---|
| <20 | mN/inch | good |
| 20~50 | mN/inch | acceptable |
| >50 | mN/inch | bad |

Peel Strength Tests

In order to investigate the bonding strength of the finally cured product formed by the B-stageable adhesive composition, a sample of the adhesive film formed by the B-stageable adhesive composition of the present disclosure was tested for 180° peel strength according to ASTM D1000. Specifically, a sample of a B-stageable adhesive film obtained from the B-stageable adhesive composition of the present disclosure was adhered to a copper plate having a thickness of 0.3 mm with manual pressure, and then put into a hot press for hot lamination at 160° C. & 0.7 MPa for 20 minutes so that the adhesive film was adhered to the copper plate. After 30 minutes, the 180° peel strength is tested on a tensile machine under the following test conditions:

(1) Peel strength test at room temperature (25° C.)

Atmospheric temperature: 25° C.;

Substrate: copper plate;

Speed: 100 mm/min;

Sample size: 150 mm length, 12.7 mm width;

Sample number: 5.

The 180° peel strength of the coating at 25° C. was evaluated according to the Result Criterions shown in Table 3-2.

TABLE 3-2

| | |
|---|---|
| 180° peel strength at 25° C. | Result Criterions |

| | | |
|---|---|---|
| <1.0 | N/mm | unacceptable |
| 1.0~1.5 | N/mm | acceptable |
| >1.5 | N/mm | Excellent |

(2) Peel strength test at 105° C. (namely heat resistance)

Atmospheric temperature & time: 105° C., after 15 min;

Substrate: copper plate;

Speed: 50 mm/min;

Sample size: 150 mm length, 12.7 mm width;

Sample number: 5.

The 180° peel strength of the coating at 105° C. was evaluated according to the Result Criterions shown in Table 3-3.

TABLE 3-3

| | |
|---|---|
| 180° peel strength at 105° C. | Result Criterions |

| | | |
|---|---|---|
| <0.4 | N/mm | unacceptable |
| 0.4~0.6 | N/mm | acceptable |
| >0.6 | N/mm | Excellent |

(3) Peel strength test at 130° C. (namely heat resistance)

Atmospheric temperature & time: 130° C., after 15 min;

Substrate: copper plate;

Speed: 50 mm/min;

Sample size: 150 mm length, 12.7 mm width;

Sample number: 5.

The 180° peel strength of the coating at 105° C. was evaluated according to the Result Criterions shown in Table 3-4.

TABLE 3-4

| | |
|---|---|
| 180° peel strength at 130° C. | Result Criterions |

| | | |
|---|---|---|
| <0.2 | N/mm | unacceptable |
| 0.2~0.3 | N/mm | acceptable |
| >0.3 | N/mm | Excellent |

90° Bending Simulation Test

In order to investigate the balance between of the flexibility at room temperature and the heat resistance of the finally cured product formed by the B-stageable adhesive composition, a sample of the adhesive film formed by the B-stageable adhesive composition of the present disclosure was tested for 90° bending simulation test. Specifically, a sample of a B-stageable adhesive film obtained from the B-stageable adhesive composition of the present disclosure was adhered to a copper plate having a size of 50 mm width, 150 mm length and 2 mm thickness, and then put into a hot press for hot lamination at 160° C. & 0.7 MPa for 20 minutes so that the adhesive film was adhered to the copper plate with 2 mm adhesive film edge width and the excess edge being removed. Then, the copper plate with the adhesive film was bent at 90° in a bending machine and the height of the bending copper plate is 20 mm. After the sample was prepared, it was put into an oven at 105° C. for 1 week.

The heat resistance of the coating was evaluated according to the Result Criterions shown in Table 3-6.

TABLE 3-6

| Heat resistance at 105° C. | Result Criterions |
|---|---|
| cracked | unacceptable |
| uncracked | good |

### Examples E1-E9

The adhesive film was prepared by the following steps using the components and amounts as listed in Table 4-1:

Step 1: In a 100 ml flask and at room temperature, the polyester V1801, V2700, V3300 or V3650 was dissolved in MEK solvent to obtain a solution with 34% solid content, and then the poly-isocyanate N 100 and the catalyst D80 were added at a suitable ratio for curing 1 day to obtain the poly-isocyanate modified polyester.

Step 2: In a 100 ml flask, the first and second epoxy resins, the carboxyl terminated polyester and the poly-isocyanate modified polyester were dissolved in methyl ethyl ketone (MEK) at room temperature to obtain a solution, and then the crosslinking agent was added and mixed uniformly;

Step 3: If necessary, other optional components such as the toughener or the like were added and stirred under the room temperature to obtain an adhesive mixture.

An adhesive film was prepared by the following steps:

Step 1: The above adhesive mixture was coated onto the surface of a 175 μm PET film by blade-coating with a coating thickness of about 35˜40 μm;

Step 2: The coated PET film was dried in an oven for 5 minutes at a temperature 105° C., and then the dried adhesive film was cut into a sample size of 150 mm length, 12.7 mm width;

Step 3: The adhesive film was laminated to a copper plate at a temperature of 160° C. and a pressure of 0.7 MPa for 20 minutes;

Step 4: the samples were cooled to room temperature (25° C.).

The adhesion strength (i.e. 180° peel strength at 25° C., 105° C., 130° C. respectively), the heat resistance, and the toughness of the coating were measured according to the test methods as described above respectively. The test results are shown in Table 4-2.

### Comparative Example C1-C9

The adhesive film samples of the comparative examples C1 to C11 were prepared by the same method as above using the components and amounts as listed in Table 4-1. The test results are shown in Table 4-2.

TABLE 4-1

| Items | E1 | E2 | E3 | E4 | E5 | E6 | E7 | E8 | E9 |
|---|---|---|---|---|---|---|---|---|---|
| 40AXM40 | 38.5% | 38.5% | 40.1% | 40.1% | 38.5% | 40.1% | 38.5% | 38.5% | 38.5% |
| SM609 | | | | | | | | | |
| DER671 | | | | | | | | | |
| V1801 | | | | | | | | | |
| V2700- | | | | | | | | | |
| poly-isocyanate | | | | | | | | | |
| modified | | | | | | | | | |
| V3300- | 10.9% | | | | | | | | |
| poly-isocyanate | | | | | | | | | |
| modified | | | | | | | | | |
| V3650- | | 10.9% | 7.6% | 10.9% | 10.9% | 7.6% | 10.9% | 10.9% | 10.9% |
| poly-isocyanate | | | | | | | | | |
| modified | | | | | | | | | |
| V3650 | | | | | | | | | |
| EPN1179 | 9.6% | 9.6% | 10.1% | 9.6% | 9.6% | 9.6% | 9.6% | | |
| EPN1183 | | | | | | | | 9.6% | |
| NPPN638S | | | | | | | | | 9.6% |
| SJ4866 | 12.7% | 12.7% | 13.4% | 12.7% | 12.7% | 13.4% | 12.7% | 12.7% | 12.7% |
| Fortegra 100 | 1.1% | 1.1% | 1.1% | 1.1% | 1.1% | 1.1% | 1.1% | 1.1% | 1.1% |
| HX-752 | 0.3% | 0.3% | 0.4% | 0.3% | | | | 0.3% | 0.3% |
| Sac-100 | | | | | 0.3% | 0.3% | 0.4% | | |
| OP935 | 26.9% | 26.9% | 28.4% | 25.3% | 26.9% | 27.9% | 26.8% | 26.9% | 26.9% |
| Items | C1 | C2 | C3 | C4 | C5 | C6 | C7 | C8 | C9 |
| 40AXM40 | | | 38.5% | 38.5% | 38.5% | 40.1% | 40.1% | 40.1% | 40.1% |
| SM609 | 38.5% | | | | | | | | |
| DER671 | | 38.5% | | | | | | | |
| V1801 | | | 10.9% | | | | | | |
| V2700- | | | | 10.9% | | | | | |
| poly-isocyanate | | | | | | | | | |
| modified | | | | | | | | | |
| V3300- | | | | | | | | | |
| poly-isocyanate | | | | | | | | | |
| modified | | | | | | | | | |
| V3650- | 10.9% | 10.9% | | | | 7.6% | 7.6% | 7.6% | 7.6% |
| poly-isocyanate | | | | | | | | | |
| modified | | | | | | | | | |
| V3650 | | | | | 10.9% | | | | |
| EPN1179 | 9.6% | 9.6% | 9.6% | 9.6% | 9.6% | 9.6% | 9.6% | 9.6% | 9.6% |
| EPN1183 | | | | | | | | | |
| NPPN638S | | | | | | | | | |
| SJ4866 | 12.7% | 12.7% | 12.7% | 12.7% | 12.7% | 12.7% | 12.7% | 12.7% | 12.7% |
| Fortegra 100 | 1.1% | 1.1% | 1.1% | 1.1% | 1.1% | 1.1% | 1.1% | 1.1% | 1.1% |
| HX-752 | 0.3% | 0.3% | 0.3% | 0.3% | 0.3% | 0.0% | | 0.0% | |
| Sac-100 | | | | | | | 0.6% | | 0.6% |
| OP935 | 26.9% | 26.9% | 26.9% | 26.9% | 26.9% | 26.9% | 26.9% | 26.9% | 26.9% |

Noted:
(a) all the amounts of 40AXM40 above are neat or solid contents of the first epoxy resin calculated from the solution thereof; and (b) “V3650-poly-isocyanate modified” refers to V3650 modified with poly-isocyanate as described above.

TABLE 4-2

| Items | E1 | E2 | E3 | E4 | E5 | E6 | E7 | E8 | E9 |
|---|---|---|---|---|---|---|---|---|---|
| Initial tackiness | good | good | good | good | good | good | good | good | good |
| 180° peel | 1.54 | 2.38 | 2.21 | 1.97 | 1.86 | 1.98 | 1.74 | 1.52 | 1.41 |
| strength, | | | | | | | | | |
| 25° C., N/mm | | | | | | | | | |
| 180° peel | 0.68 | 0.78 | 0.92 | 0.86 | 0.77 | 0.91 | 0.73 | 0.53 | 0.61 |
| strength, | | | | | | | | | |
| 105° C., N/mm | | | | | | | | | |
| 180° peel | 0.31 | 0.33 | 0.43 | 0.31 | 0.31 | 0.39 | 0.27 | 0.27 | 0.32 |
| strength, | | | | | | | | | |
| 130° C., N/mm | | | | | | | | | |
| Application | Uncracked | Uncracked | Uncracked | Uncracked | Uncracked | Uncracked | Uncracked | Uncracked | Uncracked |
| bending | | | | | | | | | |
| simulation, | | | | | | | | | |
| Items | C1 | C2 | C3 | C4 | C5 | C6 | C7 | C8 | C9 |
| Initial tackiness | good | good | good | good | good | good | good | good | good |
| 180° peel | 0.51 | 0.65 | 1.32 | 0.75 | 0.52 | 1.41 | 1.37 | 1.55 | 1.26 |
| strength, | | | | | | | | | |
| 25° C., N/mm | | | | | | | | | |
| 180° peel | 0.12 | 0.22 | 0.19 | 0.44 | 0.51 | 0.38 | 0.32 | 0.33 | 0.21 |
| strength, | | | | | | | | | |
| 105° C., N/mm | | | | | | | | | |
| 180° peel | 0.05 | 0.12 | 0.09 | 0.22 | 0.21 | 0.12 | 0.09 | 0.11 | 0.07 |
| strength, | | | | | | | | | |
| 130° C., N/mm | | | | | | | | | |
| Application | Cracked | Cracked | Cracked | Uncracked | Uncracked | Partially | Cracked | Cracked | Cracked |
| bending | | | | | | cracked | | | |
| simulation, | | | | | | | | | |

From the experimental data of Tables 4-1 and 4-2, the adhesive film of Examples E1 to E7, which satisfy the constitution of the adhesive composition in terms of the kinds and amounts of the components required in the present disclosure, exhibited a good balance between the peel strength (at 25° C.) and the peel strength (at 105° C. or 130° C., namely the heat resistance), together with the initial tackiness and the toughness. On the contrary, the adhesive film of Comparative Examples C1 to C11, which do not satisfy the constitution of the adhesive composition in terms of one or more of the kinds and amounts of the components required in the present disclosure, cannot exhibit a good balance between the peel strength (at 25° C.) and the peel strength (at 105° C. or 130° C., namely the heat resistance), together with the initial tackiness.

Although the present disclosure has been described with reference to a number of illustrative examples as explained above, it should be understood that numerous other modifications and examples can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A B-stageable epoxy adhesive composition, comprising:
(A) 20% to 50% by weight of a first epoxy resin with an epoxide equivalent of 5000 g/eq or more;
(B) 5% to 20% by weight of a second epoxy resin with an epoxide equivalent of 800 g/eq or less and having 2 to 4 epoxy functional groups;
(C) 5% to 30% by weight of a carboxyl terminated polyester;
(D) 5% to 15% by weight of a poly-isocyanate modified polyester having a glass transition temperature Tg of −13° C. to 30° C.;
(E) 0.1% to 0.5% by weight of a crosslinking agent containing 2 or more aziridine groups,
wherein all the content percentages are based on the total weight of the B-stageable epoxy adhesive composition.

2. The B-stageable adhesive composition according to claim 1,
wherein the first epoxy resin has a weight average molecular weight Mw of 10,000 g/mol or more, wherein the first epoxy resin is selected from the group consisting of bisphenol A epoxy resin, bisphenol F epoxy resin, phenolic epoxy resin, glycidyl ether epoxy resin, and a combination thereof.

3. (canceled)

4. The B-stageable adhesive composition according to claim 1, wherein the first epoxy resin is present in the B-stageable adhesive composition in an amount of 35% to 45% by weight, based on the total weight of the B-stageable adhesive composition.

5. The B-stageable adhesive composition according to claim 1, wherein the second epoxy resin has a weight average molecular weight Mw of 200˜2,000 g/mol.

6. The B-stageable adhesive composition according to claim 5, wherein the second epoxy resin is selected from the group consisting of polyurethane modified bisphenol A epoxy resin, polyurethane modified bisphenol F epoxy resin, polyurethane modified phenolic epoxy resin, polyurethane modified trisphenolmethane epoxy resin, polyurethane modified glycidyl amine epoxy resin, polyurethane modified aminophenol epoxy resin, polyurethane modified naphthalene epoxy resin, and a combination thereof.

7. The B-stageable adhesive composition according to claim 1, wherein the second epoxy resin is present in the B-stageable adhesive composition in an amount of 6% to 10% by weight, based on the total weight of the B-stageable adhesive composition.

8. The adhesive composition according to claim 1, wherein the carboxyl terminated polyester has an acid value of 20˜80 mg KOH/g.

9. The adhesive composition according to claim 1, wherein the carboxyl terminated polyester or the poly-isocyanate modified polyester comprises a dicarboxylic acid unit and a glycol unit, wherein the dicarboxylic acid unit comprises one or more of succinic acid, adipic acid, cyclohexane diacid, suberic acid, phthalic acid, naphthalene acid, trimellitic acid, or pyromellitic acid, and the glycol unit comprises one or more of ethylene glycol, propylene glycol, butanediol, pentanediol, hexanediol, octanediol, decanediol, diethylene glycol, dipropylene glycol, dimethylolpropane, or dimethylolethane.

10. The B-stageable adhesive composition according to claim 1, wherein the carboxyl terminated polyester is selected from carboxyl terminated phthalate polyester, carboxyl terminated adipate polyester, or a combination thereof.

11. The B-stageable adhesive composition according to claim 1, wherein the poly-isocyanate modified polyester is phthalate polyester, poly-isocyanate modified adipate polyester or a combination thereof, which is modified by a poly-isocyanate selected from tolylene diisocyanate, diphenyl methane diisocyanate, hexamethylene diisocyanate, isophorone diisocyanate, or a combination thereof.

12. The adhesive composition according to claim 1, wherein the poly-isocyanate modified (hydroxyl-terminated) polyester has a weight average molecule weight of 20,000 g/mol or more.

13. The B-stageable adhesive composition according to claim 1, wherein the poly-isocyanate modified polyester has a glass transition temperature Tg of −11° C. to 16° C.

14. The B-stageable adhesive composition according to claim 1, wherein the crosslinking agent is 1,1′-isophthaloyl bis(2-methylaziridine), Trimethylolpropane tris(2-methyl-1-aziridinepropionate), 2-((3-Aziridin-1-ylpropionyl)methyl)-2-ethylpropane-1,3-diyl bis(aziridine-1-propionate), or a combination thereof.

15. The B-stageable adhesive composition according to claim 1, further comprising a solvent.

16. The B-stageable adhesive composition according to claim 15, wherein the solvent is selected from N,N-Dimethyl formamide, methyl ethyl ketone (MEK), hexane, heptane, cyclohexane, toluene, xylene, or a combination thereof.

17. The B-stageable adhesive composition according to claim 15, wherein the solvent is present in the B-stageable adhesive composition in an amount of 30% to 70% by weight, based on the total weight of the B-stageable adhesive composition.

18. The B-stageable adhesive composition according to claim 1, further comprising a toughener, a flame retardant, or a combination thereof.

19. The B-stageable adhesive composition according to claim 18, wherein the toughener is present in the B-stageable adhesive composition in an amount of 0.5% to 2.0% by weight, based on the total weight of the B-stageable adhesive composition.

20. The B-stageable adhesive composition according to claim 18, wherein the flame retardant is present in the B-stageable adhesive composition in an amount of 1.0% to 30.0% by weight, based on the total weight of the B-stageable adhesive composition.

21. An article comprising a substrate and a coating formed of the adhesive composition according to claim 1 on a surface of the substrate, wherein the article comprises a plate, tape, roll, film or tube.

22. (canceled)
